(19) United States
(12) Patent Application Publication
(10) Pub. No.: US 2016/0132866 A1
(43) Pub. Date: May 12, 2016

(54) DEVICE, SYSTEM, AND METHOD FOR CREATING VIRTUAL CREDIT CARD

(71) Applicant: Tencent Technology (Shenzhen) Company Limited, Shenzhen (CN)

(72) Inventors: Liu Gui, Shenzhen (CN); Wu Li, Shenzhen (CN); Gong Chen, Shenzhen (CN); Zhang Wen Jing, Shenzhen (CN); Zhang Jin Ming, Shenzhen (CN); Tan Jin Wen, Shenzhen (CN); Guo Yi Xin, Shenzhen (CN); Ye Wa, Shenzhen (CN); Hou Liang, Shenzhen (CN); Xu Zhen Yu, Shenzhen (CN); Zhang Bin, Shenzhen (CN); Chen Wei, Shenzhen (CN); Zheng Hao Jian, Shenzhen (CN); Jiang Ying Yi, Shenzhen (CN); Song Ling Yun, Shenzhen (CN); Jiang Nan, Shenzhen (CN)

(73) Assignee: Tencent Technology (Shenzhen) Company Limited

(21) Appl. No.: 14/982,931

(22) Filed: Dec. 29, 2015

Related U.S. Application Data
(63) Continuation of application No. PCT/CN2015/070202, filed on Jan. 6, 2015.

(30) Foreign Application Priority Data
Mar. 13, 2014 (CN) 201410093653.9

(51) Int. Cl. G06Q 20/34; G06Q 20/24; H04L 29/08

(52) U.S. Cl. CPC G06Q 20/351; H04L 67/306; H04L 67/1097; G06Q 20/24

(57) ABSTRACT

The present disclosure directs to method, device, system for creating virtual credit card. The method may include: acquiring a subset of real-name information from a user interface of a terminal device; searching the real-name information stored in the first server with the subset of the real-name information; upon the real-name information is found in the first server, sending the real-name user information to a second server; finding whether the real-name information associates with a credit card account stored in the second server; after finding the credit card account is stored in the second server, creating, by the second server, a virtual credit card account; and storing the virtual credit card associated with the virtual credit card account in the data storage of the first server.

### CROSS-REFERENCE TO RELATED APPLICATIONS

This application is a continuation of International Application No. PCT/CN2015/070202, filed on Jan. 6, 2015, which claims priority to Chinese Patent Application No. 201410093653.9, filed on Mar. 13, 2014, which is incorporated by reference in its entirety.

### FIELD OF THE TECHNOLOGY

The present disclosure relates to the technology of data-processing in the areas of database, networking and computer programming, particularly to the data processing technology of a device, a system and a method for creating virtual credit card without physical form.

### BACKGROUND OF THE TECHNOLOGY

The credit card may be created and managed by the corresponding management server. A typical credit card has a physical form and the credit card may associate with a bank. With the development of the data processing technology in the areas of database, networking and computer programming, the credit card may not need the physical form, and the creation and use of the credit card may not associate the bank only.

### SUMMARY OF THE TECHNOLOGY

A device, a system and a method for creating a virtual credit card are provided with examples of the present disclosure. The virtual credit card may not have a physical form of the credit card and the use and creation of the virtual credit card may not associate with the bank only. After the creation of the virtual credit card, the virtual credit card may be used and saved at a third party other than the bank.

The example for a device for creating a virtual credit card is provided. The device includes a first server having a data storage containing pre-stored real-name information and associated electronic account information, wherein the first server is configured to: acquire a subset of real-name information from a user interface of a terminal device wherein the subset of the real-name information comprises at least a portion of a user name or identification number associated with the electronic account saved in the data storage; search for the real-name information stored in the data storage using the subset of the real-name information; send the real-name user information to a second server if the real-name information is found in the data storage; receive a notification from the second server if a credit card account stored in the second server associates with the real-name information, and a virtual credit card is created by the second server; and store the virtual credit card associated with the virtual credit card account.

The example of the present disclosure provides a system for creating virtual credit card to be stored in a data storage. The system may include a first server having the data storage, a terminal device having a user interface communicating to the first server, and a second server communicating to the first server.

The terminal device of the system is configured to: acquire a subset of real-name information from a user interface, wherein the subset of the real-name information comprises at least a portion of: a user name or a user identification number wherein the portion is associated with an electronic account saved in the first server.

The first server of the system is configured to: receive the subset of the real-name information, search the real-name information stored in the data storage with the subset of the real-name information, wherein the real-name information is pre-stored in the data storage; upon the real-name information is found in the data storage, send the real-name user information to a second server.

The second server is configured to: receive the real-name user information, and find whether the real-name information associates with a credit card account stored in the second server; after finding the credit card account is stored in the second server, create a virtual credit card account; and the first server is further configured to: store the virtual credit card associated with the virtual credit card account in the data storage.

The example for a method for creating a virtual credit card to be stored in a data storage may include steps of: acquiring a subset of real-name information from a user interface of a terminal device, wherein the subset of the real-name information comprises at least a portion of: a user name or a user identification number wherein the portion is associated with an electronic account saved in a first server; receiving, by the first server, the subset of the real-name information, searching the real-name information stored in the first server with the subset of the real-name information, wherein the real-name information is pre-stored in the data storage of the first server; upon the real-name information is found in the first server, sending the real-name user information to a second server by the first server; receiving, by the second server, the real-name user information by the second server, and finding whether the real-name information associates with a credit card account stored in the second server; after finding the credit card account is stored in the second server, creating, by the second server, a virtual credit card account; and storing the virtual credit card associated with the virtual credit card account in the data storage of the first server.

### BRIEF DESCRIPTION OF THE DRAWINGS

To describe the technical solutions in the examples of the present disclosure more clearly, the following briefly introduces the accompanying drawings needed for describing the examples or the prior art. Apparently, the accompanying drawings in the following description show some examples of the present disclosure, and persons of ordinary skill in the art can still derive other drawings from these accompanying drawings without creative efforts.

The system and/or method may be better understood with reference to the following drawings and description. Non-limiting and non-exhaustive descriptions are described with reference to the following drawings. The components in the FIG.s are not necessarily to scale, emphasis instead being placed upon illustrating principles. In the FIG.s, like referenced numerals may refer to like parts throughout the different FIG.s unless otherwise specified.

FIG. 1 is a structure schematic showing implementing environment for each example of the present disclosure;

FIG. 2 is a method flow chart showing a method for creating credit card account according to an example of present disclosure;

FIG. 3A is a method flow chart showing a method for creating credit card account according to another example of present disclosure;

FIG. 3B is an interface schematic showing about acquiring subset of real-name information according to the example of present disclosure;

FIG. 3C is an interface schematic showing a typical validation interface according to the example of present disclosure;

FIG. 3D is interface schematics showing the virtual credit card account during and after validation according to the example of present disclosure;

FIG. 3E is an interface schematic showing the binding result according to the example of present disclosure;

FIG. 3F is a method flow chart showing a method for creating credit card account according to the example of present disclosure;

FIG. 4 is a frame diagram showing a device for creating credit card account according to an example of present disclosure;

FIG. 5 is a frame diagram showing a device for creating credit card account according to another example of present disclosure;

FIG. 6 is a frame diagram showing a device for creating credit card account according to an example of present disclosure;

FIG. 7 is a frame diagram showing a device for creating credit card account according to another example of present disclosure;

FIG. 8 is a frame diagram showing a device for creating credit card account according to an example of present disclosure;

FIG. 9 is a frame diagram showing a device for creating credit card account according to another example of present disclosure;

FIG. 10 is a frame diagram showing a system for creating credit card account according to the example of present disclosure;

FIG. 11 is a frame diagram showing a terminal according to the example of present disclosure; and

FIG. 12 is a frame diagram showing a server according to the example of present disclosure.

### DETAILED DESCRIPTION

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one example,” “an example,” “examples,” “one embodiment,” “an embodiment,” “example embodiment,” or the like in the singular or plural means that one or more particular features, structures, or characteristics described in connection with an embodiment or an example is included in at least one embodiment or one example of the present disclosure. Thus, the appearances of the phrases “in one embodiment,” “in an embodiment,” “in an example embodiment,” “in one example,” “in an example,” or the like in the singular or plural in various places throughout this specification are not necessarily all referring to the same embodiment. Furthermore, the particular features, structures, or characteristics may be combined in any suitable manner in one or more embodiments or examples.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” may include “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the terms “module,” “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a terminal device, and a communication network. The server and the terminal device may be coupled through the communication network for information exchange, such as sending/receiving identification information, sending/receiving data files such as splash screen images, etc. Although only one terminal device and one server are shown in the environment, any number of terminals or servers may be included, and other devices may also be included.

The communication network may include any appropriate type of communication network for providing network connections to the server and terminal device or among multiple servers or terminal devices. For example, communication network may include the Internet or other types of computer networks or telecommunication networks, either wired or wireless. In a certain embodiment, the disclosed methods and apparatus may be implemented, for example, in a wireless network that may include at least one terminal device.

In some cases, the terminal device or the device may refer to any appropriate user terminal with certain computing capabilities, such as a personal computer (PC), a work station computer, a server computer, a hand-held computing device (tablet), a smart phone or mobile phone, or any other user-side computing device. In various embodiments, the terminal device may include a network access device. The terminal device may be stationary or mobile.

A server, as used herein, may refer to one or more server computers configured to provide certain server functionalities, such as database management and search engines. A server may also include one or more processors to execute computer programs in parallel.

It should be noticed that, the embodiments/examples and the features in the embodiments/examples may be combined with each other in a no conflict condition. This invention will become apparent from the following detailed description when taken in conjunction with the accompanying drawings.

It should be noticed that, the steps illustrated in the flowchart of the drawings may be performed in a set of computer device with executable program codes. And the order of the steps may be different from that in the drawings under some status, although a logic order is shown in the flowchart.

The purpose, technical proposal and advantages in the examples of the present disclosure will become more clear and complete from the following detailed description when taken in conjunction with the appended drawings. Apparently, the examples described thereinafter are merely a part of examples of the present disclosure, not all examples. Persons skilled in the art can obtain all other examples without creative works, based on these examples, which pertains to the protection scope of the present disclosure.

An existing method for creating credit card account may include: the account management server receives a request for creating credit card account of a user which is triggered in the page, according to the request for creating credit card account, an information input box is displayed to the user in the page, with the information input box used for entering the name, ID number, address, email and phone number, and other user information. Then, the account management server receives user information which is input into the corresponding input box, and provides the user information to staff for validation. When the user receives the feedback information from the staff indicating that the validation is passed; the account management server create a new credit card account based on the user information and generates the corresponding real credit card. Finally, the staff will mail the real credit card corresponding to the credit card account, so that user could use the credit card account by the credit card in the subsequent course.

During the implementation of the present disclosure, at least the following defects found in the background art:

When applying for a credit card account in a web page, users need to enter more information, and user information need to be validated by staff, and such operations are more time consuming, which results in time-consuming to this operation, together with longer process and inefficiency for creating credit card account.

A device, a system and a method for creating a virtual credit card are provided with examples of the present disclosure. The virtual card creation may only require the input of a subset of user information. The virtual credit card may not have a physical form of the credit card and may be used the same way as the credit card with the same form. In addition, the virtual credit card may be created and saved at a reliable party other than a bank. In the following disclosure, the first server may refer to one or more processing servers that are operated by a third party other than a bank, the second server may be operated by a bank. The virtual credit card account may refer to the account that is created for the virtual credit card. The virtual credit card account and the virtual credit card may be used exchangeably under some circumstances. The terminal device refers to any user device that may have a user interface to allow a user to enter into information for applying for a credit card. The present disclosure provides method, device, system for creating virtual credit card, and the technical solution is described hereinafter:

In the first aspect, the present disclosure provides a device for creating credit card account, which is set in a first server, which may include:

A first receiving module, configured to receive a subset of real-name information; and

A first sending module, configured to send a real-name user information that matches the subset of real-name information which is received by the first receiving module to a second server, with the real-name user information being configured to trigger the second server to create a virtual credit card account of the user, after detecting there is an existing credit card account to correspond to the real-name user information, and the real-name user information being saved in the first server.

In the second aspect, the present disclosure provides a device for creating credit card account, which is set in a terminal device, which may include:

A first acquiring module, configured to acquire the subset of real-name information of a user;

A first sending module, configured to send the subset of real-name information acquired by the first acquiring module, with the subset of real-name information is configured to trigger the first server to send a real-name user information that matches the subset of real-name information to a second server, the real-name user information being saved in the first server, and the real-name user information being configured to trigger the second server to detect whether there is an existing credit card account to correspond to the real-name user information, if yes, creating a virtual credit card account of the user.

In the third aspect, the present disclosure provides a device for creating credit card account, which is set in a second server, which may include:

A first receiving module, configured to receive user real-name information which matches the subset of real-name information sent by the first server, with the real-name user information being saved in the first server;

An account detecting module, configured to detect whether there is an existing credit card account which is corresponding to the user real-name information received by the first receiving module; and

An account creating module, configured to create a virtual credit card account of the user, after the account detecting module detects there is a credit card account.

In the fourth aspect, the present disclosure provides a system for creating credit card account, which may include: a first server, a terminal device communicating to the first server, and a second server communicating to the first server;

The first server may include a device for creating credit card account as described in the first aspect, said terminal device comprises a device for creating credit card account as described in the second aspect, and said second server comprises a device for creating credit card account as described in the third aspect.

In the fifth aspect, the present disclosure provides a method for creating credit card account, which may include:

Acquiring a subset of real-name information, and sending subset of real-name information to a first server;

Receiving the subset of real-name information, and sending real-name user information which matches the subset of real-name information to a second server by the first server, with the real-name user information being saved in the first server; and

Receiving the real-name user information by the second server, and detecting whether there is an existing credit card account to correspond to the real-name user information, if there exist the credit card account, creating a virtual credit card account of the user.

In the sixth aspect, the present disclosure provides a method for creating credit card account which is employed by a first server, and the method may include:

Receiving subset of real-name information; and

Sending the user real-name information which matches to the subset of real-name information to a second server, with the real-name user information being configured to trigger the second server to create virtual credit card account of the user, after detecting there exist credit card account corresponding to the real-name user information, and the real-name user information being saved in the first server.

In the seventh aspect, the present disclosure provides a method for creating credit card account which is employed by a terminal device, and the method may include:

Acquiring a subset of real-name information of a user; and sending the subset of real-name information of the user to the first server, with the subset of real-name information being configured to trigger the first server to send a real-name user information that matches the subset of real-name information to a second server, the real-name user information being saved in the first server, and the real-name user information being configured to trigger the second server to detect whether there exist credit card account which is corresponding to the real-name user information, if yes, creating a virtual credit card account of said user.

In the eighth aspect, the present disclosure provides a method for creating credit card account which is employed by a second server, and the method may include:

Receiving user real-name information which matches the subset of real-name information sent by the first server, with the real-name user information being saved in the first server;

Detecting whether there is an existing credit card account which is corresponding to the user real-name information; and

Creating a virtual credit card account of the user, if detecting there exist the credit card account.

The first server sends the real-name user information that matches the subset of real-name information to the second server, with the real-name user information being saved in the first server; the second server detects whether there exists credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

The accomplishment, functionality, and advantage of the present disclosure will be further described hereinafter, by combining with drawings and the examples. The examples hereinafter are merely the description of the present disclosure, which does not limit the present disclosure.

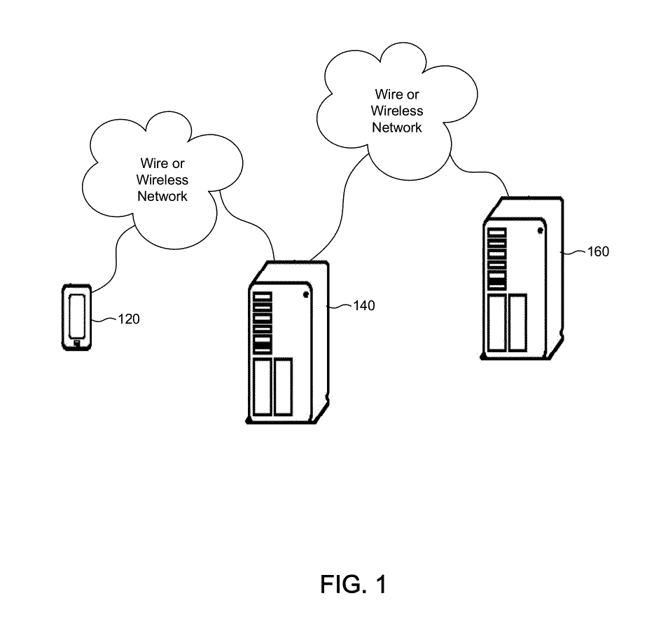

As shown in FIG. 1, it shows an implement environment related to various examples of present disclosure. The implement environment may include: a terminal 120, a first server 140 and a second server 160.

The terminal 120 may be mobile phones, tablet PCs, e-book readers, MP3 players (Moving Picture Experts Group Audio Layer III), MP4 (Moving Picture Experts Group Audio Layer IV) players, laptop computers and desktop computers, etc.

The terminal 120 on which application terminal device or browser may have been installed visits web terminal device of the application through a browser. The application terminal device and web terminal device are collectively called the terminal device in the examples of present disclosure, no special statement below.

The first server 140 may be a server, or a server cluster consisting of several servers, or a cloud computing service center. The first server 140 and the terminal 120 provide businesses like electronic exchange to each other. The first server 140 is usually established by internet service providers.

The second server 160 may be a server, or server cluster consisting of several servers, or a cloud computing service center. The second server 160 is used to provide resource saving account, credit card account, and to create and manage virtual credit card account according to examples the present disclosure. The second server 160 is usually established by financial institutions, such as bank. The resource saving account is an account making the pre-stored resource as exchange resource, such as saving card account in the bank; Credit card account is an account which is overdrawn to exchange resources according to credit of the user, such as credit card account in the bank.

The terminal 120 may communicate with the first server 140 via wireless network or wired network, and the first server 140 may communicate with the second server 160 via wireless network or wired network.

It should be noted first that, in various examples of present disclosure, the terms involves:

Real-name user information is mainly used to verify identity of the user who applies for creating a virtual credit card account. Real-name user information may include user name and identity document number, the identity document number is usually identity card number. In other possible cases, identity document number can also be any number which uniquely identifies user identity, just like passport number, MTPs number, or military officer number. Additionally, real-name user information usually may include the user phone number as well.

Electronic account is create by real-name validation and passing the validation, and provides with real-name user information to the second server. The user could open different electronic account according to the functions provides on the terminal device. For instance, open electronic payment accounts on the terminal device with electronic payment function, open social account son the terminal device with social function, opened video game accounts on the terminal device with game function, opened email accounts on the terminal device with email function, open electronic financial accounts on the terminal device with financial function, open electronic services accounts on the terminal device with information query service function. As at least two of the above functions are provided on the terminal device, the corresponding electronic accounts could be bound and related to each other.

Electronic payment account is an account used to complete electronic payment employing the electronic payment function provided by the user on the terminal device. Electronic payment account possesses exchange and transfer functions, such as transferring part of the resource pre-stored in the electronic payment account to purchase of goods by the user, or transferring part of the resources from other accounts into this electronic payment account, etc. For example, the electronic payment account may be Wechat payment account, Paypal account, Jingdong account, or Meituan account, etc.

Electronic social account is configured for user to accomplish a social function in the social functions of provided by the terminal device. For example, the electronic social accounts may be WeChat accounts, current accounts, Line account, etc.

E-mail account is configured for user to accomplish sending/receiving e-mail in sending/receiving e-mail functions of provided by the terminal device. For example, e-mail accounts may be Google account, Yahoo account, Netease account, Sina account, Microsoft account, etc.

Electronic financial account is configured for user to accomplish electronic financial in electronic financial functions of provided by the terminal device. For example, electronic financial account may be e-billing accounts, stock accounts, etc.

Electronic serving account is configured for user to accomplish electronic serving in electronic serving functions of provided by the terminal device. For example, electronic serving account may be ink weather service accounts account, Tiger Maps account, etc.

The user history data is used as reference to determine the credit limit of virtual credit card account by the second server. The user history data could may include the history data in at least one electric account, for example, history payment data, history social data, history email data, history financing data and history login data. In detail, history payment data can include at least one kind of information selected from number of history payments, frequency of history payments, and history payments amount; history social data can include at least one kind of information selected from history online spent, history social number, and history speech times; history email data can include at least one kind of information selected from history email number and history email amount; history financial data can include at least one kind of information selected from history total investment and history gain amount; history login data can include at least one kind of information selected from history login times, history frequency, and length of login time. User history data may also include the user personal information, such as age, date of birth, place of birth, education, history attending school, home address, contact information, and immediate family members, and so on. User history data is generally more than the real-name information for a user.

The following describes the solutions for creating credit card account in detail with reference to examples.

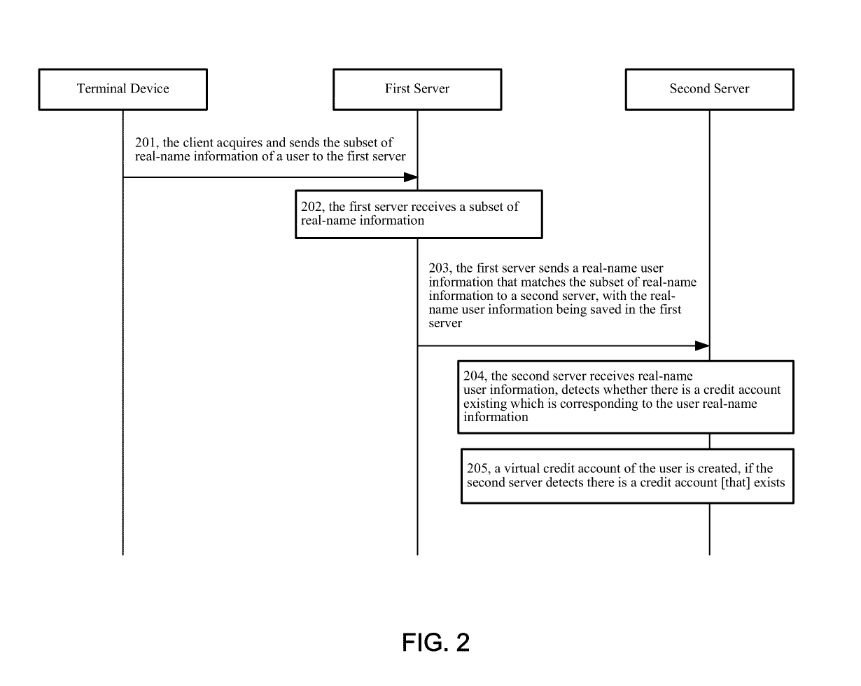

As shown in FIG. 2, it shows a flow chart of the method for creating credit card account according to an example of present disclosure, the method for creating credit card account, may include following steps:

Step 201, the terminal device acquires and sends a subset of real-name information of a user to the first server; the subset of real-name information may be used to match real-name user information;

Step 202, the first server receives subset of real-name information;

Step 203, the first server sends a real-name user information that matches the subset of real-name information to a second server, with the real-name user information being saved in the first server;

Step 204, the second server receives real-name user information, detects whether there is an existing credit card account which is corresponding to the user real-name information;

wherein the credit card account may be created through the existing method for creating credit card account, the credit card account credit limit may be based on the credit of the user; and

Step 205, a virtual credit card account of the user is created, if the second server detects there is a credit card account that exists.

Because there is an existing credit card account in the second server, and the second server have collected the user information to pass the validation thereto, the user is confirmed to be trusted, and a virtual credit card account is created for the user directly, without collecting the user information and making a validation thereto again, which can omit the comprehensive user information collection and manual validation process, thus, the creation process for virtual credit card account is shorter, the creation of the virtual credit card account is efficient.

The virtual credit card account is newly created and not corresponding to the credit card account, that is, the virtual credit card account and the credit card account are independent from each other. For instance, a credit card account is newly created in the second server, then the user has card 1 corresponding to the credit card account; while a virtual credit card account is newly created in the second server, then the user could acquire card 2 corresponding to the virtual credit card account, with card 1 being different from card 2. The card 2 may be physical card. However, in most cases, card 2 is the virtual credit card that may be saved in the first sever.

The above-described step 201 may be separately implemented as the method for creating the virtual credit card account on terminal device side, the above-described steps 202, and 203 may be separately implemented as the method for creating the virtual credit card account on the first server side, and the above-described steps 204 and 205 may be separately implemented as the method for creating the virtual credit card account on second server side.

In conclusion, the method for creating the virtual credit card account is performed by: the first server sends the user real-name information which matches to the subset of real-name information to a second server, with the real-name user information being saved in the first server and corresponding to the electric account; the second server detects whether there exists the credit card account which is corresponding to the real-name user information, if yes, a virtual credit card account of said user is created. The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

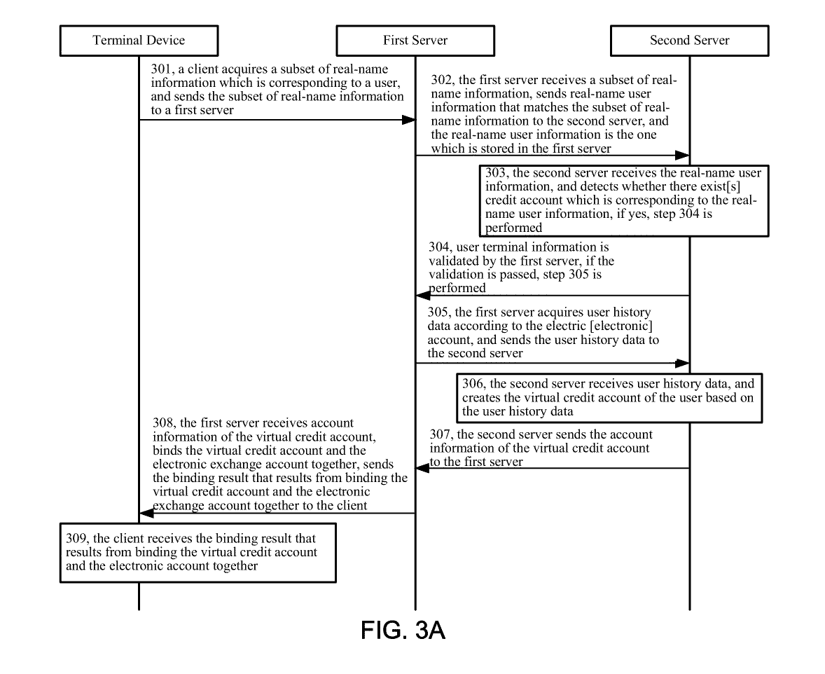

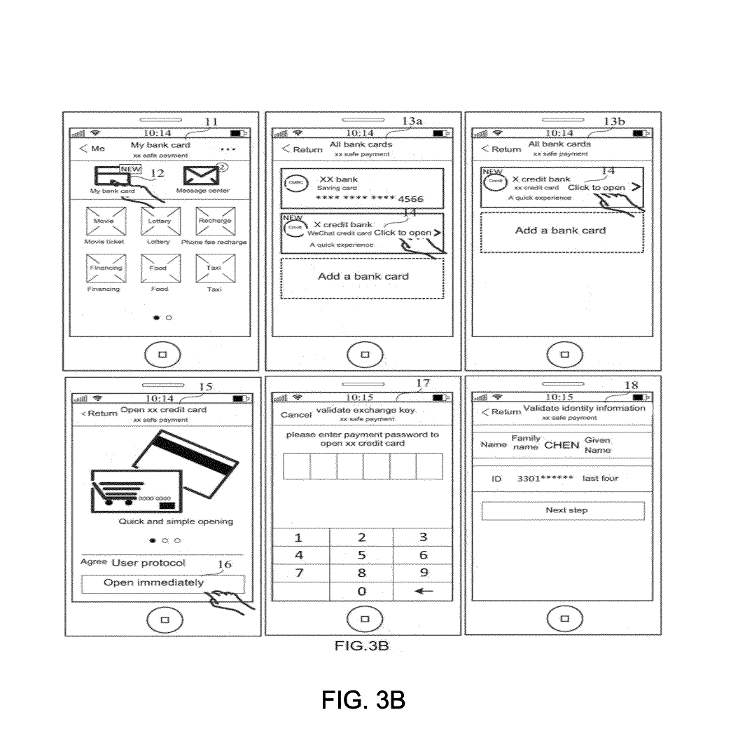

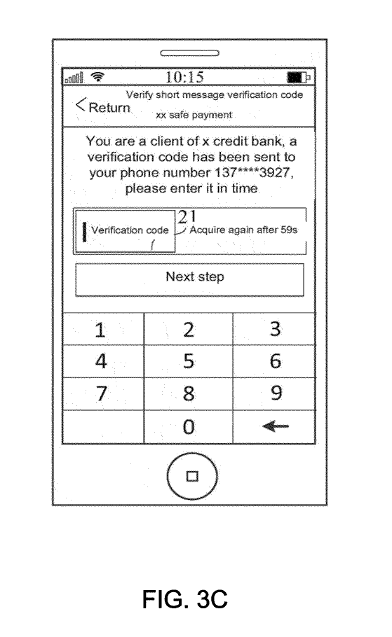

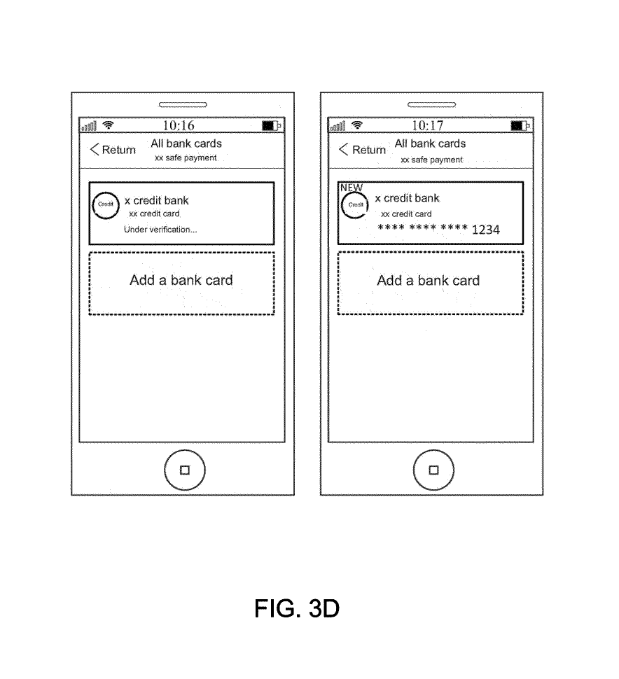

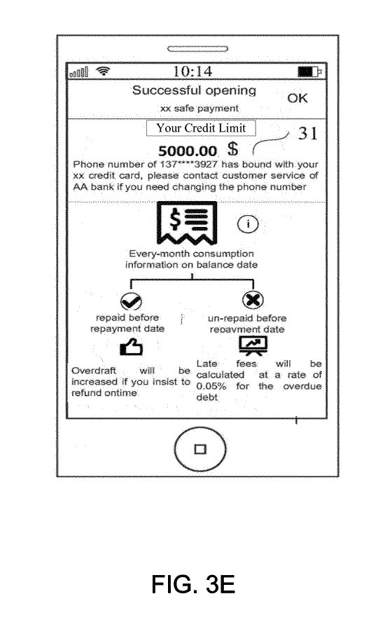

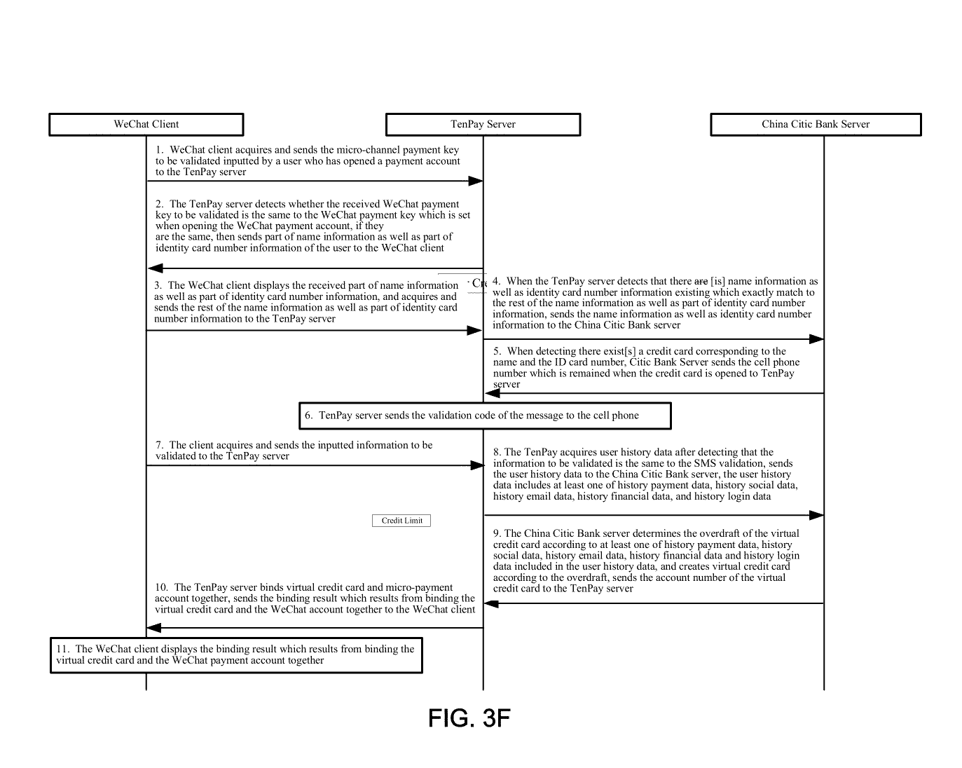

As shown in FIG. 3A, it shows a flow chart of the method for creating the virtual credit card account according to the other example of present disclosure, the method for creating credit card account, may include following steps.

Step 301, a terminal device acquires a subset of real-name information which is corresponding to a user, and sends the subset of real-name information to a first server.

If the user needs to apply for creating a virtual credit card account, the terminal device needs to acquire real-name user information of the user, so that the second server can validate user identity according to the real-name user information provided by the terminal device.

However, inputting real-name user information will not only increase the inputted information content to reduce the efficiency of creating virtual credit card account, but also easily result in the leak of information to reduce the security of creating virtual credit card account.

Therefore, the terminal device can merely acquire and send the subset of real-name information to the first server, and the first server then sends the pre-stored real-name user information acquired to the second server, so as to increases the security of creating virtual credit card account.

Since the subset of real-name information is used to match complete user information, the subset of real-name information may be part of the real-name user information, also may be the information corresponding to real-name user information. The present examples are described based on that the subset of real-name information is a part of the real-name user information.

The real-name user information is set and stored in the first server that an electronic account is opened and saved in the first server for the real-name user information. As such, acquiring the subset of real-name information of the user may include: acquiring the subset of real-name information of user who has an electronic account that is created and saved in the first server.

In detail, the subset of real-name information may include at least one class of subset of real-name sub-information, each class of subset of real-name sub-information is part of the real-name sub-information of the corresponding class of real-name user information. For example, the real-name sub-information included in the subset of real-name information may be name information and identity card number information respectively. Therefore, at least one class of subset of real-name sub-information may include part of name information as well as part of identity card number information. Another class of subset of real-name sub-information may include part of identity card number information. Thus, at least one class of subset of real-name sub-information may include part of name information as well as part of identity card number information.

Optionally, in order to ensure that the user himself applies for a virtual credit card account to increase the security of creating virtual credit card account, the terminal device may also validate user identity before acquiring the subset of real-name information. The terminal device may acquire the subset of real-name information when validating that it is the user himself applying for the virtual credit card account, and does not respond to this application operations when validating that it is not the user himself applying for the virtual credit card account.

In detail, before acquiring the subset of real-name information of a user who has opened an electronic exchange account, the method further may include:

The terminal device acquires an exchange key to be validated, and sends the exchange key to be validated to the first server; and

The first server receives the exchange key to be validated, detects whether the exchange key to be verified is the same to the pre-stored exchange key, when detecting that the exchange key to be verified is the same to the pre-stored exchange key, the first server triggers the terminal device to acquire the subset of real-name information of a user, and the exchange key is the one stored in the first server.

The exchange key is settled and stored in the first server when the user opens the electronic exchange account. The terminal device may show the inputting interface in which the exchange key to be validated is inputted by the user, determine what the user inputs in the interface as the exchange key to be validated, and send the exchange key to be validated to the first server. It is the duty of the first server to detect whether the exchange key to be validated is the same to the exchange key. When detecting that the exchange key to be validated is the same to the pre-stored exchange key, the first server may determine that it is the user himself applying for a virtual credit card account; when detecting that the exchange key to be validated is not the same to the pre-stored exchange key, the first server may determine that it is not the user himself applying for a virtual credit card account.

As shown in FIG. 3B, it shows an interface schematic of acquiring subset of real-name information. If need to apply for creating a virtual credit card account, the user first clicks on button 12 “my bank card” in interface 11 “my bank card”, the terminal device will jump to interface 13 “all bank card”; after clicking on “Click immediately open” button 14 in interface 13 “all bank card” by the user, the terminal device will jump to interface 15 “open xx credit card”; after clicking on button 16 “open” on interface 15 “open xx credit card”, the terminal device will jump to interface 17 “validate exchange key”; If the user inputs the exchange key to be validated in interface 17 “validate exchange key”, the terminal device will jump to interface 18 “validate identity information”. In the present example, assume that subset of real-name information what the user needs to enter may include part of name information as well as part of identity card number information. After inputting the last one of the name and the last four of the identity card number respectively in the corresponding location of the interface 18 “validate identity information”, the terminal device can immediately acquire the user subset of real-name information.

Step 302, the first server receives subset of real-name information, sends real-name user information that matches subset of real-name information to the second server, and the real-name user information is the one which is stored in the first server.

The first server may find the real-name user information which matches the subset of real-name information in at least one of the pre-stored real-name user information, and sends the real-name user information acquired after matching to the second server.

In detail, sending the real-name user information which matches the subset of real-name information to the second server, may include:

The first server sends the user real-name information to the second server, when at least one class of subset of real-name sub-information is some aspects of the corresponding information of the user real-name information.

The first server can match each piece of real-name user information to the subset of real-name information respectively, and sends the real-name user information which exactly matches to the second server.

Step 303, the second server receives the real-name user information, and detects whether there exists a credit card account which is corresponding to the real-name user information, if yes, step 304 is performed.

The credit card account may be created using the previously existing method. Corresponding relationship between the real-name user information of the user who has successfully applied for a credit card account and the different credit card accounts have been stored in the second server, therefore, the second server detects whether the user has successfully applied for a credit card account in the past according to the corresponding relationship.

Because the second server have collected the user information to pass the validation thereto when creating the credit card account after detecting that there is an existing credit card account in the second server, the user is confirmed to be trusted by the second server, and step 304 is triggered to create virtual credit card account, without collecting the user information and making a validation thereto again, which may omit the comprehensive user information collection and manual validation process, thus, the creation process for virtual credit card account is shorter, the efficiency on creating virtual credit card account is improved.

Step 304, user terminal information is validated by the first server, if the validation is passed, step 305 is performed.

Before triggering the second server to create the virtual credit card account, the first server validates the user terminal information, to guarantee the user who applies for a virtual credit card account is the one who has at least one existing credit card account.

In the present example, the first server validates user terminal information via one or any combination of SMS validation, IM validation, voice validation, and email validation. For example, the first server sends one or any of SMS, IM, voice messages, e-mail to the terminal, and validates whether the terminal receives the above-mentioned information.

In detail, validating the user terminal information may include:

The first server receives a validation terminal identity acquired and sent by the terminal device; and

Validating the validation terminal identity.

Each resource saving account is bound with at least one validation terminal identity which is usually the phone number reserved by the user when opening resource saving account. In other possible cases, validation terminal identity may also be e-mail address, IM number, landline phone number, and so on.

When detecting that there exists the credit card account, the second server first acquires the validation terminal identity which is bound to the credit card account, and then sends the validation terminal identity to the first server, and guarantees the user who applies for a virtual credit card account is the one who has at least one existing credit card account, via the validation to the user according to the validation terminal identity.

In detail, validating validation terminal identity may include:

The first server sends validation information to the validation terminal indicated by the validation terminal identity; and

Receiving validation information, detecting whether information to be validated is the same to the validation information, if detecting the information to be validated is the same to the validation information, then validation for validation terminal identity is passed.

If the validation terminal identity is the phone number inputted by the user on the terminal device, the first server sends validation information to the corresponding phone according to the phone number. In general, validation information is composed of several numbers and or letters.

Meanwhile, the first server triggers the terminal device to display related validation interface. Referring to FIG. 3C, it shows an interface schematic of a typical validation interface. The terminal device instructs the user to enter the information to be validated into the input box 21 through reminders displayed in the validation interface.

If the user is the one holding the credit card account, and the cell phone number which is remained when applying for the credit card account is just the one the user is using, the user could review the validation information sent from the first server. Afterward, the user inputs the information to be validated to the validation interface displayed on the terminal device, that is, inputs the validation information which has been reviewed to the validation interface as the information to be validated, and the terminal device sends the information to be validated to the first server to be validated.

Preferably, when the terminal where the terminal device is running is the validation terminal, the terminal device could identify and extract the information to be validated from the message received by the validation terminal, and sends the information to be validated to the first server to be validated.

The first server compares the validation information sent before with the information to be validated, and detects whether both of them are identical with each other. If the validation information is identical with the information to be validated, the current user is the one who holds the credit card account, in this situation; the first server verifies that the user is probably authorized to create the virtual credit card account by the account management server. Since the validation to the user is passed when the user applies to create a credit card account, the user should be authorized to create the virtual credit card account.

Step 305, the first server acquires user history data according to the electric account, and sends the user history data to the second server.

As shown in FIG. 1 which shows the implement environment, the first server may acquire the user history data from the history data generated from the electronic account used by the user, for example, history payment data, history social data, history email data, history financing data, and history login data.

The terminal device may have various functions. The first server may acquire historical data from other bound or associated electronic account respectively. The historical data in different electronic accounts may be stored either in the same server or different servers. In this example, it is to be described in the case of storing in different servers.

For instance, the terminal device possesses electronic payment function and social function, and then the electronic payment function is bound with the electronic social function. The first server may directly read the historical payment data from the user payment records. History social data and history login data from the social server which is corresponding to the historical social account, history payment data, historical login data, and history social data as the user history data are sent to the second server.

In step 306, the second server receives user history data, and creates the virtual credit card account of the user based on the user history data.

The second server receives user history data, and is triggered to create the virtual credit card account of the user. The virtual credit card account is newly created and not corresponding to the credit card account, that is, the virtual credit card account and the credit card account are independent from each other. For instance, a credit card account is newly created in the second server, then the user has card 1 corresponding to the credit card account; while a virtual credit card account is newly created in the second server, then the user could acquire card 2 corresponding to the virtual credit card account, with card 1 being different from card 2. Card 2 may or may not have a physical form. When Card 2 does not have a physical form, it may also be saved in the first server.

In addition, the user history data is used as reference to determine the credit limit of virtual credit card account by the second server. The credit limit identifying the max spending amount for the virtual credit card account, and the resource (available credit) could be exchanged for physical objects or virtual goods. The virtual credit card account needs to be set with a certain credit limit, to avoid malicious withdrawal happening on the user who holds the virtual credit card account. The balance of the credit card should not exceed the certain credit limit, while the user uses the virtual credit card account to exchange for goods.

In detail, creating the user credit card account according to the user history data may include:

(1) the second server accesses at least one of history payment data, history social data, history email data, history financial data, and history login data of the user history data;

(2) the second server determines the credit limit of the virtual credit card account according to at least one of history payment data, history social data, history email data, history financial data and history login data, with the credit limit identifying the max spending amount for the virtual credit card account; and

(3) the second server creates the virtual credit card account according to the credit limit.

The second server determines the credit limit according to historical login data. For example, the more the user logins in the electronic exchange account in history, the greater the credit limit is; for example, the longer the online time is, the greater the credit limit is.

Since the history login data reflects the activity in user daily life, the activity may be used as a reference to the user credit. And/or, the second server determines the credit limit according to history exchange data. For example, the more the user exchanges in the electronic payment account in history the greater the credit limit is; for example, the greater the amount of the historical payment is, the greater the credit limit is; In the present example, it only takes history login data and/or history payment data for example to illustrate the determining of the credit limit, the first server may also determine the credit limit in the same way according to other history data.

When the user history data has history exchange data, and/or history social data, and/or history email data, and/or history financial data, and/or history login data, the first server may determine an appropriate credit limit by the combination of history exchange data, and/or history social data, and/or history email data, and/or history financial data, and/or history login data. If the user history data also may include basic personal information, the second server may determine a more appropriate credit limit by the combination of history exchange data, and/or history social data, and/or history email data, and/or history financial data, and/or history login data as well as basic personal information at the moment. Since the second server may determine the user credit limit according to the user actual usage, therefore the accuracy of setting the credit limit of the virtual credit card account credit limit is increased.

Referring to FIG. 3D which is an interface schematics showing the virtual credit card account during and after validation according to the example of present disclosure, an example is described as the user opens the electronic payment account without binding the bank card. The schematic showing virtual credit card account during validation is presented on the left, and the schematic showing virtual credit card account after validation is presented on the right.

What should be added, step 305 could be performed before step 304, or after step 304, or at the same time. This example is described based on the condition that step 305 is performed after step 304.

Step 307, the second server sends the account information of the virtual credit card account to the first server.

The second server sends the account information of the virtual credit card account to the first server after creating the virtual credit card account of the user; the account information may include the account number and the credit limit. The account information may also include the date of creating the virtual credit card account, the validity period of the virtual credit card account, the deadline of filling resources, and so on. The virtual credit card may be created and saved in the first server by using the account information.

Step 308, the first server receives account information of the virtual credit card account, binds the virtual credit card account and the electronic exchange account together, sends the binding result that results from binding the virtual credit card account and the electronic exchange account together to the terminal device; and

After binding the both by the first server, the user may select the items desired to exchange after logging in the electronic exchange account, and then debit the virtual credit card account to complete the payment.

Step 309, the terminal device receives the binding result that results from binding the virtual credit card account and the electronic account together.

The terminal device receives and displays the binding result sent by the first server. The binding results may carry account number of virtual credit card account, the credit limit, the date of creating virtual credit card account, the validity period of the virtual credit card account, the deadline of filling resources, and any other information.

As shown in FIG. 3E, it shows an interface schematic of the binding result, the terminal device may display the credit limit 31 in order to inform the user after the binding result is received.

The above steps 301 and 309 may be implemented separately as the method for creating virtual credit card account on terminal device side, the above steps 302, 304, 305 and 308 may be implemented separately as the method for creating virtual credit card account on first server side, the above-described steps 303, 306 and 307 may be implemented separately as the method for creating virtual credit card account on the second server side.

As shown in FIG. 3F, it shows a flow chart of the method for creating virtual credit card. In this example, it takes that the terminal device is the WeChat client, the electronic exchange account is the Tenpay server, the second server is the China Citic Bank server, the electronic account is the WeChat payment account, the virtual credit card account is the China Citic virtual credit card, the resource saving account is the saving card, the exchange key is the WeChat payment key for example to describe the procedure of opening a virtual credit card.

1. WeChat client acquires and sends the micro-channel payment key to be validated inputted by a user who has opened a payment account to the Tenpay server.

2. The Tenpay server detects whether the received WeChat payment key to be validated is the same to the WeChat payment key which is set when opening the WeChat payment account, if they are the same, then sends part of name information as well as part of identity card number information of the user to the WeChat client.

3. The WeChat client displays the received part of name information as well as part of identity card number information, and acquires and sends the rest of the name information as well as part of identity card number information to the Tenpay server.

4. When the Tenpay server detects that there are name information as well as identity card number information existing which exactly match to the rest of the name information as well as part of identity card number information, sends the name information as well as identity card number information to the China Citic Bank server.

5. When detecting there exists a credit card corresponding to the name and the ID card number, Citic Bank server sends the cell phone number which is remained when the credit card is opened to Tenpay server.

6. Tenpay server sends the validation code of the message to the cell phone.

7. The terminal device acquires and sends the inputted information to be validated to the Tenpay server.

8. The TenPay acquires user history data after detecting that the information to be validated is the same to the SMS validation, sends the user history data to the China Citic Bank server. The user history data may include at least one of history payment data, history social data, history email data, history financial data, and history login data.

9. The China Citic Bank server determines the credit limit of the virtual credit card according to at least one of history payment data, history social data, history email data, history financial data and history login data included in the user history data, and creates virtual credit card according to the credit limit, sends the account number of the virtual credit card to the Tenpay server.

10. The TenPay server binds virtual credit card and micro-payment account together, sends the binding result which results from binding the virtual credit card and the WeChat account together to the WeChat client.

11. The WeChat client displays the binding result which results from binding the virtual credit card and the WeChat payment account together.

In conclusion, the device for creating credit card account is carried out of: the first server sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

In addition, the user real-name information is sent to the second server, when each subset of real-name sub-information of said at least one class of subset of real-name sub-information is some aspects of the corresponding information of the user real-name information. It is required the user to input part of information, which could simple the input process and the efficiency on creating credit card account is improved thereby.

The present disclosure provides a method for creating a virtual credit card to be stored in a data storage. The method may include:

Acquiring a subset of real-name information from a user interface of a terminal device, wherein the subset of the real-name information comprises at least a portion of: a user name or a user identification number wherein the portion is associated with an electronic account saved in a first server;

Receiving, by the first server, the subset of the real-name information, searching the real-name information stored in the first server with the subset of the real-name information, wherein the real-name information is pre-stored in the data storage of the first server;

Upon the real-name information is found in the first server, sending the real-name user information to a second server by the first server;

Receiving, by the second server, the real-name user information by the second server, and finding whether the real-name information associates with a credit account stored in the second server;

After finding the credit account is stored in the second server, creating, by the second server, a virtual credit card account; and

Storing the virtual credit card associated with the virtual credit card account in the data storage of the first server.

The virtual credit card may be stored in the first server after the second server creates the virtual card account. The virtual credit card may be tied with the electronic account and/or the exchange resource account. The first server may provide the cardholder means to access the card, such as an additional user interface to access the card via a terminal device. The terminal device may be cardholder's own mobile phone, mobile terminal or another other devices. The access to the virtual credit card may be provided to the cardholder after the verification of the cardholder is passed. Any verification means, either currently known or later developed, may be used for such verification purpose. By this way, the user does not need to have a physical credit card.

In case the virtual credit card tied with the electronic exchange account, the historical data stored or obtained by the first server may be used to verify the cardholder for the virtual credit card. In addition, the cardholder's own phone may provide built-in methods for the verification, such as fingerprint verification.

As such, the first server may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

The electronic account of the method may be one of: an electronic social account, an electronic payment account, an electronic game account, an email account, a financial account, and an electronic service account.

Before creating the virtual credit card account, the method may further include: acquiring user history data stored in the data storage of the first server according to the electronic account, and sending the user history data to the second server; and receiving the user history data by the second server, and creating the virtual credit card account by using the user history data.

When creating the virtual credit account by using the user history data, the method may include: analyzing the user history data by accessing at least one of: user payment data, user social data, historical email data, historical financing data and historical login data that are included in the user history data received by the second server; and determining, by the second server, the credit limit of the virtual credit card account according to the analyzed user history data.

Before creating the virtual credit card account, the method may further include: validating the terminal device by the first server, wherein validating the terminal device may include: receiving, by the first server from the second server, a validation terminal identity that is bound to the credit account stored in the second server; sending validation information to a second user interface according to the validation terminal identity received by the first server; in response to sending the validation information, receiving second validation information to be validated from the terminal device; determining whether the second validation information matches the validation information; and validating the terminal device by saving an indicator in the data storage of the first server to indicate the terminal device is validated if the second validation information matches the validation information.

When validating user terminal information by the first server, the method may further include: validating the terminal device by using at least one of: SMS validation, instant messaging validation, voice validation, and email validation.

After creating the virtual credit card account, the method may further include: sending the account information of the virtual credit card account to the first server by the second server; receiving the account information of the virtual credit card account by the first server, and binding, by the first server, the virtual credit card associating with the virtual credit card account and the electronic account saved in the data storage of the first server.

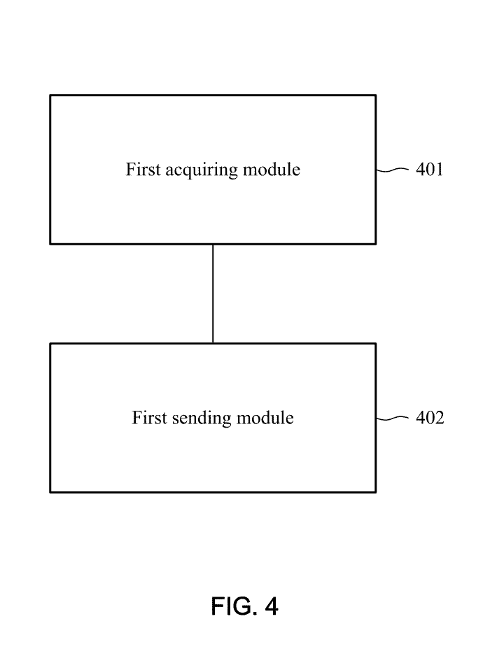

Referring to FIG. 4, it is a frame diagram showing a device for creating virtual credit card account according to an example of present disclosure. The device for creating virtual credit card account which could be employed in the terminal device may include:

A first acquiring module 401, configured to acquire the subset of real-name information of a user; and

A first sending module 402, configured to send the subset of real-name information acquired by the first acquiring module 401, with the subset of real-name information is configured to trigger the first server to send a real-name user information that matches the subset of real-name information to a second server, the real-name user information being saved in the first server, and the real-name user information being configured to trigger the second server to detect whether there is an existing credit card account to correspond to the real-name user information, if yes, creating a virtual credit card account of the user.

In conclusion, the device for creating credit card account is carried out of: the subset of real-name information is acquired and sent to the first server, and the subset of real-name information triggers the first server to send the real-name user information which is matched the subset of real-name information, with the real-name user information being saved in the first server, the real-name user information is used to trigger the second server detects whether there exist credit card account which is corresponding to the real-name user information, if yes, a virtual credit card account of said user is created.

The process of creating the virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

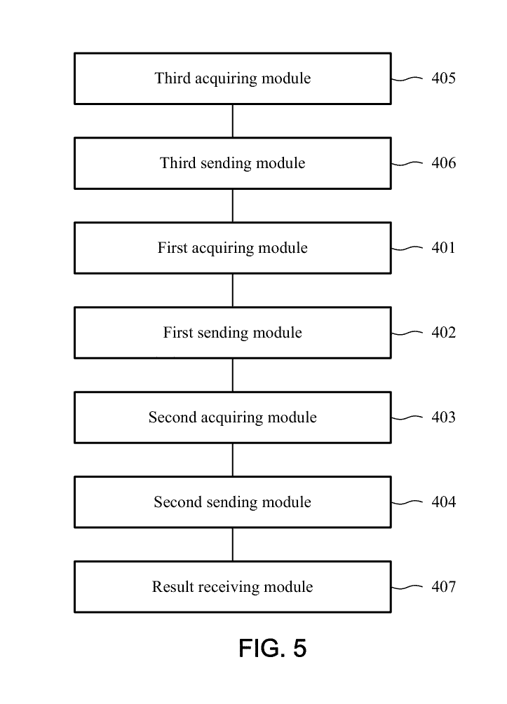

As shown in FIG. 5, it shows a frame diagram of device for creating credit card account according to the other example of present disclosure. The device for the virtual creating credit card account may be applied to the terminal device. The device for creating credit card account may include a first acquiring module 401 and a first sending module 402.

The first acquiring module 401 is configured to acquire and send the subset of real-name information of the user.

The first sending module 402, configured to send the subset of real-name information acquired by the first acquiring module 401, with the subset of real-name information is configured to trigger the first server to send a real-name user information that matches the subset of real-name information to a second server, the real-name user information being saved in the first server, and the real-name user information being configured to trigger the second server to detect whether there is an existing credit card account to correspond to the real-name user information, if yes, creating a virtual credit card account of the user.

Optionally, first acquiring module 401 is configured to acquire the subset of real-name information of the user who has the electronic account.

Optionally, the electronic account is one of electronic social account, electronic payment account, electronic game account, email accounts, financial account, and electronic service account.

Optionally, the subset of real-name information comprises at least one class of subset of real-name sub-information.

Optionally, at least one class of subset of real-name sub-information comprises part of name information as well as part of identity card number information.

Optionally, the device further may include:

A second acquiring module 403, configured to acquire information to be validated after the first sending module 402 sends the subset of real-name information to the first server, and the information to be validated is input, after the first server acquires the validation terminal identity which is bound to the credit card account and sends the validation information to the validation terminal which is directed by the validation terminal identity; and

A second sending module 404, configured to send the information to be validated acquired by the second acquiring module 403 to the first server, allowing the first server to trigger the second server to an operation of creating a virtual credit card account of the user when the information to be validated is identical with the validation information.

Optionally, the device further may include:

A third acquiring module 405, configured to acquire exchanging key to be validated, before the first acquiring module 401 acquires the subset of real-name information of the user;

A sending module 406, configured to send the exchanging key to be validated acquired by third acquiring module 405, allowing the first server to trigger the terminal device to acquire the subset of real-name information of the user who has opened electric account, when detecting that the exchanging key to be validated is identical with the predetermined exchanging key, with the exchanging key being saved in the first server to corresponding to the electric account.

Optionally, the device further may include:

A result receiving module 407, configured to receive the binding result by binding the virtual credit card account and the electric account which is sent by the first server, after the first sending module sends the subset of real-name information to the first server, with the binding result being the account information of the virtual credit card account from the second server to the first server, and being sent by the first server after binding the virtual credit card account and the electric account together.

In conclusion, the device for creating credit card account is carried out of: the subset of real-name information is acquired and sent to the first server, and the subset of real-name information triggers the first server to send the real-name user information which is matched the subset of real-name information, with the real-name user information being saved in the first server, the real-name user information is used to trigger the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

In addition, the information to be validated is sent to the first server, allowing the first server to trigger the second server to create a virtual credit card account of the user when the information to be validated is identical with the validation information, so that the user ID is validated, and the safety for creating virtual credit card account is improved.

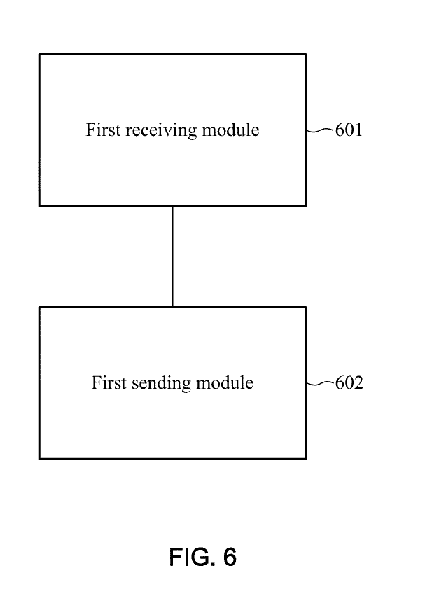

As shown in FIG. 6, it shows a frame diagram of device for creating the virtual credit card account according to an example of present disclosure. The device for creating credit card account is employed by the first server, and the device may include:

A first receiving module 601, configured to receive a subset of real-name information; and

A first sending module 602, configured to send a real-name user information that matches the subset of real-name information which is received by the first receiving module 601 to a second server, with the real-name user information being configured to trigger the second server to create virtual credit card account, after detecting there exists credit card account corresponding to the real-name user information, with the real-name user information being saved in the first server.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exists credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

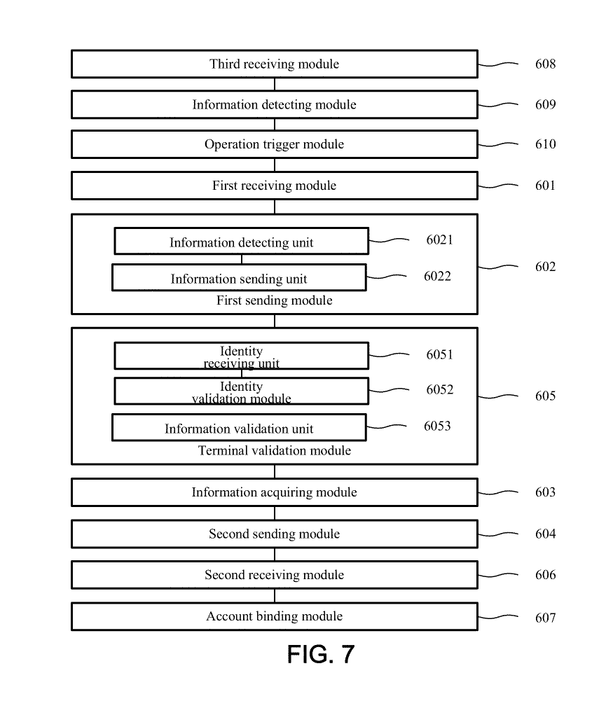

As shown in FIG. 7, it shows a frame diagram of device for creating credit card account according to the example of present disclosure, and the device for creating credit card account is employed by the first server. The device for creating credit card account may include: a first receiving module 601 and a first sending module 602.

The first receiving module 601 is configured to receive subset of real-name information.

The first sending module 602 is configured to send a real-name user information that matches the subset of real-name information which is received by the first receiving module 601 to a second server, with the real-name user information being configured to trigger the second server to create the virtual credit card account, after detecting there is no existing credit card account to correspond to the real-name user information, and the real-name user information being saved in the first server.

Optionally, the device may further include:

An information acquiring module 603, configured to acquire user history data according to an electronic account, with the electronic account being configured to acquire subset of real-name information; and

A second sending module 604, which is configured to send the user history data acquired by the data acquiring module 603, with the user history data being configured to create the virtual credit card account.

Optionally, the subset of real-name information may include at least one class of subset of real-name sub-information.

Optionally, at least one class of subset of real-name sub-information may include part of name information as well as part of identity card number information.

Optionally, the first sending module 602, may further be configured to send the user real-name information to the second server, when each subset of real-name sub-information of at least one class of subset of real-name sub-information is some aspects of the corresponding information of the user real-name information.

Optionally, the device further may include:

A terminal validation module 605, configured to validate user terminal information before the first sending module 602 sends the real-name user information which is matched the subset of real-name information to the second server, if the validation is passed, an operation of creating virtual credit card account of the user by the second server is triggered thereby.

Optionally, the terminal validation module 605 further may include:

An identity acquiring unit 6051, which is configured to receive a validation terminal identity which is bound to the credit card account sent from the second server; and

An identity validation module 6052, which is configured to validate the validation terminal identity acquired by the identity acquiring unit.

Optionally, the identity validation module 6052 may further be configured to send the validation information to the validation terminal indicated by the validation terminal identity; receive information to be validated; detect whether the information to be validated is identical with the validation information; if yes, the validation for the validation terminal identity is passed.

Optionally, terminal validation module 605 further may include:

An information validation unit 6053, configured to validate terminal information of the user via one or any combination of SMS validation, IM validation, voice validation, and email validation.

Optionally, the device further may include:

A second receiving module 606, which is configured to receive account information of the virtual credit card account sent by the second server, after the first sending module 601 sends the real-name user information which match the subset of real-name information;

An account binding module 607, which is configured to bind the virtual credit card account and the electronic exchange account together received by the second receiving module 606, and send the binding result that results from binding the electronic account and the virtual credit card account to the terminal device, allowing the terminal device to receive the binding result that results from binding the electronic account and the virtual credit card account.

Optionally, the device further may include:

A third receiving module 608, configured to receive exchange key to be validated sent by the terminal device, before the first receiving module 601 receives the subset of real-name information sent by the terminal device.

An information detecting module 609, configured to detect that the exchange key to be verified which is received by third receiving module 608 is the same to the pre-stored exchange key, with the exchange key being the one stored in the first server and associated with the electronic exchange account; and

An operation trigger module 610, configured to trigger the operation to receive the subset of real-name information sent by the terminal device when the information detecting module 609 detect that the exchange key to be verified is the same to the pre-stored exchange key.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

In addition, the user real-name information is sent to the second server, when each subset of real-name sub-information of said at least one class of subset of real-name sub-information is some aspects of the corresponding information of the user real-name information. It is required the user to input part of information, which could simple the input process and the efficiency on creating credit card account is improved thereby.

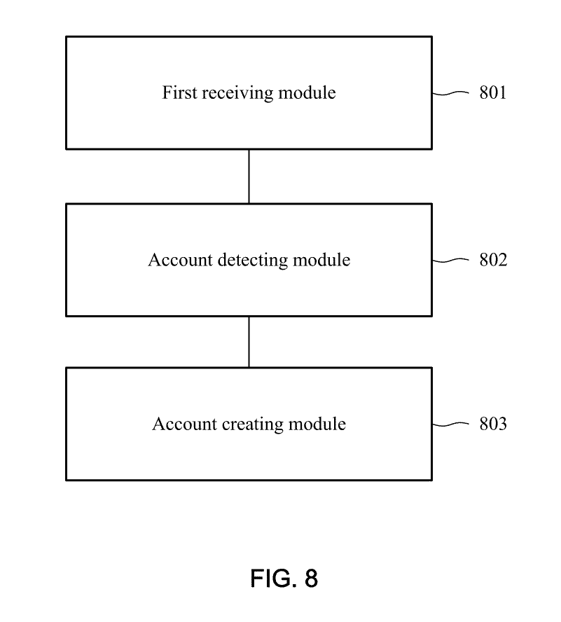

As shown in FIG. 8, it shows a frame diagram of the device for creating credit card account according to the example of present disclosure. The device for creating credit card account may be employed by the second server. The device for creating credit card account may include:

A first receiving module 801, configured to receive user real-name information which matches the subset of real-name information sent by the first server, with the real-name user information being saved in the first server;

An account detecting module 802, configured to detect whether there is an existing credit card account which is corresponding to the user real-name information received by the first receiving module; and

An account creating module 803, configured to create a virtual credit card account of the user, when the credit card account is detected by the account detecting module 802.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

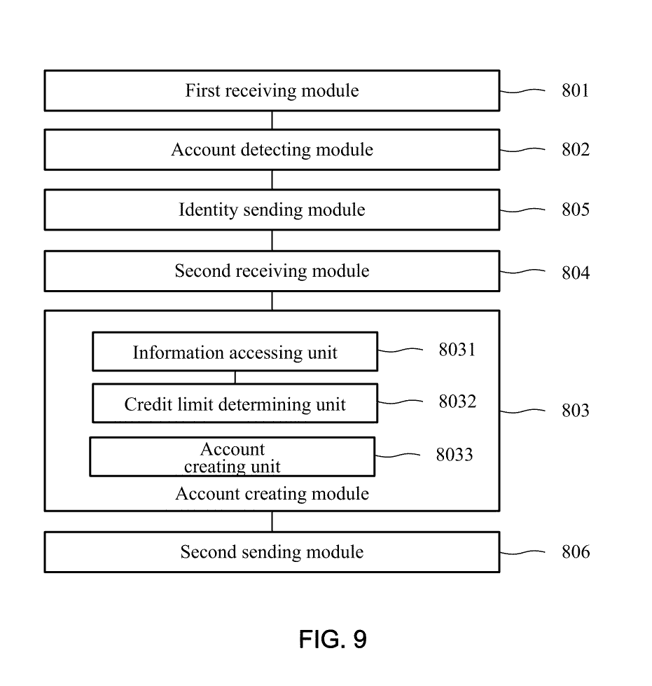

As shown in FIG. 9, it shows a structural diagram of device for creating credit card account according to another example of present disclosure, the device for creating credit card account may be employed by the second server. The device for creating credit card account may include: a first receiving module 801, an account detecting module 802 and an account creating module 804.

The first receiving module 801 is configured to receive user real-name information which matches the subset of real-name information, with the real-name user information being saved in the first server.

The account detecting module 802 is configured to detect whether there is an existing credit card account which is corresponding to the user real-name information received by the first receiving module.

The account creating module 803 is configured to create a virtual credit card account of the user, after the account detecting module 802 detects there is a credit card account.

Optionally, the device further may include:

A second receiving module 804, configured to receive user history data sent by the first server before the account creating module 803 creates the virtual credit card account of the user, with the user history data being acquired by the first server according to an electronic account, the electronic account being configured to acquire a subset of real-name information, and the user history data being configured to create the virtual credit card account.

Optionally, account creating module 803 is used to create the virtual credit card account of the user according to the user history data.

Optionally, account creating module 803 may include:

An information accessing unit 8031, configured to access at least one of user payment data, user social data, history email data, history financing data and history login data of the user history data;

A credit limit determining unit 8032, configured to determine the credit limit of the virtual credit card account according to at least one of history payment data, history social data, history email data, history financing data and history login data which are all accessed by the information accessing unit 8031, with the credit limit identifying the max spending amount for the virtual credit card account; and

An account creating unit 8033, configured to create said virtual credit card account according to the credit limit determined by the credit limit determining unit.

Optionally, the device further may include:

An identifying module 805, configured to, before the account creating module 803 creates the virtual credit card account of the user, send the validation terminal identity which is bound to the credit card account to the first server, allowing the first server to send the validation information to the validation terminal indicated by the validation terminal identity, so that the terminal device acquires information to be validated, and sends it to the first server, which trigger the second server to create the virtual credit card account of the user by when detecting the information to be validated is identical with the validation information.

Optionally, the device further may include:

A second sending module 806, configured to send the account information of the virtual credit card account to the first server after the account creating module 803 create the virtual credit card account of the user, allowing the first server to receive the account information of the virtual credit card account, bind the virtual credit card account and the electronic account together, and send the binding result that results from binding the virtual credit card account and the electronic exchange account to the terminal device, with the terminal device receiving the binding result that results from binding the virtual credit card account and the electronic account.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

In addition, the credit limit of the virtual credit card account is determined according to historical exchange information and/or historical social information and account type, and the virtual credit card account is created according to the credit limit, the credit limit of the user may be determined according to actual usage of the user, so the accuracy of setting the credit limit of the virtual credit card account is increased.

The present disclosure also provides a device for creating a virtual credit card. The device includes a first server having a data storage containing pre-stored real-name information and associated electronic account information, wherein the first server may be configured to:

Acquire a subset of real-name information from a user interface of a terminal device wherein the subset of the real-name information comprises at least a portion of a user name or identification number associated with the electronic account saved in the data storage;

Search for the real-name information stored in the data storage using the subset of the real-name information; send the real-name user information to a second server if the real-name information is found in the data storage; receive a notification from the second server if a credit card account stored in the second server associates with the real-name information, and a virtual credit card is created by the second server; and

Store the virtual credit card associated with the virtual credit card account.

The first server of the device may store the virtual credit card after the second server creates the virtual card account. The virtual credit card may be tied with the electronic account and/or the exchange resource account stored in the data storage of the first server. The first server may provide the cardholder means to access the card, such as an additional user interface to access the card via a terminal device. The access to the virtual credit card may be provided to the cardholder after the verification of the cardholder is passed. Any verification means, either currently known or later developed, may be used for such verification purpose. By this way, the user does not need to have a physical credit card.

In case the virtual credit card tied with the electronic exchange account, the first server may store or obtain the historical data and used the historical data to verify the cardholder for the virtual credit card. In addition, the first server may detect the verification is passed when the cardholder's own phone provides built-in methods for the verification, such as fingerprint verification.

As such, the first server of the device may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

The electronic account saved in the first server may be one of: an electronic social account, an electronic payment account, an electronic game account, an email account, a financial account, and an electronic service account.

The first server of the device may be configured to: acquire user history data stored in the data storage according to the electronic account, and send the user history data to the second server wherein the user history data is used by the second server for creating the virtual credit card account.

The first server of the device may be configured to validate the terminal device, wherein the first server may be configured to: receive, from the second server, a validation terminal identity that is bound to the credit account stored in the second server; send validation information to a second user interface according to the received validation terminal identity; in response to send the validation information, receive second validation information from the terminal device; determine whether the second validation information matches the validation information; and validate the terminal device by saving an indicator in the data storage to indicate the terminal device is validated if the second validation information matches the validation information.

The first server of the device may be configured to: validate the terminal device by using at least one of: SMS validation, instant messaging validation, voice validation, and email validation.

The first server of the device may be configured to: receive the account information of the virtual credit card account from the second server, and bind the virtual credit card associating with the virtual credit card account and the electronic account saved in the data storage.

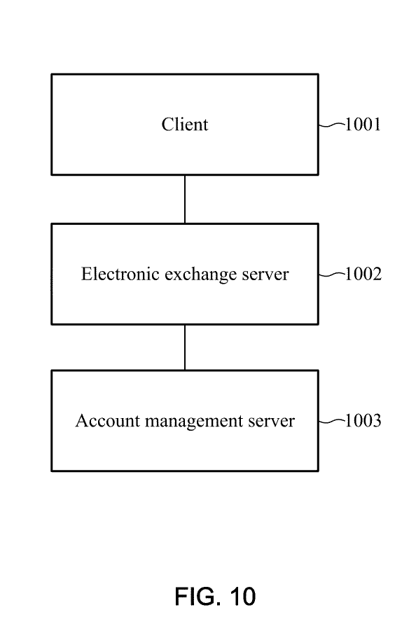

As shown in FIG. 10, it shows a frame diagram of a system for creating credit card account according to the example of present disclosure, and the system for creating credit card account may include:

A terminal device 1001, configured to acquire the subset of real-name information of the user, and send the subset of real-name information to the first server 1002;

A first server 1002, which is configured to receive subset of real-name information, and send real-name user information which matches to the subset of real-name information to the second server 1003, with the real-name user information being stored in the first server 1002; and

A second server 1003, configured to receive user real-name information, with the real-name user information being saved in the first server, and detect whether there is an existing credit card account which is corresponding to the user real-name information, if there exist a credit card account, virtual credit card account of the user is created.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

A system for creating credit card account according to an example of present disclosure, which may include: a terminal device 1001, a first server 1002, and a second server 1003.

The terminal device 1001 is configured to acquire the subset of real-name information of the user, and send the subset of real-name information to the first server 1002.

The first server 1002 is configured to receive subset of real-name information, and send real-name user information which matches to the subset of real-name information to the second server 1003, with the real-name user information being stored in the first server 1002.

The second server 1003, configured to receive user real-name information, with the real-name user information being saved in the first server, and detect whether there is an existing credit card account which is corresponding to the user real-name information, if there exist a credit card account, virtual credit card account of the user is created.

Optionally, the terminal device 1001, configured to acquire the subset of real-name information of the user who holds the electronic account.

Optionally, the electronic account is one of electronic social account, electronic payment account, electronic game account, email accounts, financial account, and electronic service account.

Optionally, the first server 1002 is configured to acquire user history data according to the electronic account, and send the user history data to the second server 1003, before the virtual credit card account of the user is created by the second server 1003

The second server 1003 is further configured to receive the user history data, which is the basic for creating a virtual credit card account of the user.

Optionally, the second server 1003 is further configured to create a virtual credit card account of the user according to user history data.

Optionally, the second server 1003 is further configured to access at least one of the user history data which may include history payment data, history social data, history email data, history financial data, and history login data; determine the credit limit of the virtual credit card account according to at least one of history payment data, history social data, history email data, history financial data and history login data, with the credit limit identifying the max spending amount for the virtual credit card account; the virtual credit card account is created according to the credit limit.

Optionally, the subset of real-name information may include at least one class of subset of real-name sub-information.

Optionally, at least one class of subset of real-name sub-information may include part of name information as well as part of identity card number information.

Optionally, the first server 1002 is further configured to send the user real-name information to the second server 1003, when each subset of real-name sub-information of said at least one class of subset of real-name sub-information is some aspects of the corresponding information of the user real-name information.

Optionally, before the virtual credit card account of the user is created by the second server 1003, the first server 1002 is configured to validate user terminal information, if the validation is passed, and an operation of creating the virtual credit card account of the user by the second server is triggered.

Optionally, the first server 1002 is configured to receive the validation terminal identity which is bound to the credit card account sent by the second server 1003, and validate the validation terminal identity received by the identity acquiring unit.

Optionally, the first server 1002 is configured to send the validation information to the validation terminal indicated by the validation terminal identity, receive information to be validated, detect whether the information to be validated is identical with the validation information; if yes, an operation of creating the virtual credit card account of the user by the second server 1003 is triggered.

Optionally, the first server 1002 is configured to validate user terminal information via one or any combination of SMS validation, instant messaging validation, voice validation, and email validation by the first server.

Optionally, the terminal device 1001 is configured to acquire exchanging key to be validated, and send the exchanging key to be validated to the first server 1002, before acquires the subset of real-name information of the user who has opened the electronic account.

The first server 1002 is further configured receive the exchanging key to be validated and detect whether the exchanging key to be validated is identical with the predetermined exchanging key, if yes, an operation of acquiring the subset of real-name information of the user by the terminal device is triggered, with the exchanging key being saved in the first server 1002 to corresponding to the electric account.

Optionally, the second server 1003 is configured to send account information of the virtual credit card account of the user to the first server 1002.

The first server 1002 is further configured to receive the account information of the virtual credit card account, bind the virtual credit card account and the electronic account together, and send the binding result that result from binding the electronic account and the virtual credit card account to the terminal device 1001.

The terminal device 1001 is further configured to receive the binding result that results from binding the electronic account and the virtual credit card account.

In conclusion, the device for creating credit card account is carried out of: the first server receives the subset of real-name information, and sends the user real-name information which matches to the subset of real-name information to a second server, with the real-name user information being saved in the first server and corresponding to the electric account; the second server detects whether there exist credit card account which is corresponding to the real-name user information, if yes, a virtual credit card account of said user is created.

The process of creating virtual credit card account combining the existing credit card account, enables the second server determine the user who has opened the credit card account according to the real-name user information, which can omit the comprehensive user information collection and manual validation process, instead, it creates a virtual credit card account for user, and solves the problem of time consuming for credit card account application, long creation process and inefficient creation, therefore the efficiency on creating credit card account is improved.

In addition, the user real-name information is sent to the second server, when each subset of real-name sub-information of said at least one class of subset of real-name sub-information is some aspects of the corresponding information of the user real-name information. It is required the user to input part of information, which could simple the input process and the efficiency on creating credit card account is improved thereby.

The present disclosures provides a system for creating virtual credit to be stored in a data storage, comprising: a first server, a terminal device having a user interface communicating to the first server, and a second server communicating to the first server; wherein:

The terminal device is configured to: acquire a subset of real-name information from a user interface, wherein the subset of the real-name information comprises at least a portion of: a user name or a user identification number wherein the portion is associated with an electronic account saved in the first server;

The first server is configured to: receive the subset of the real-name information, search the real-name information stored in the data storage with the subset of the real-name information, wherein the real-name information is pre-stored in the data storage; upon the real-name information is found in the data storage, send the real-name user information to a second server;

The second server is configured to: receive the real-name user information, and find whether the real-name information associates with a credit account stored in the second server; after finding the credit account is stored in the second server, create a virtual credit card account; and

The first server is configured to: store the virtual credit card associated with the virtual credit card account in the data storage.

The virtual credit card may be stored in the first server after the second server creates the virtual card account. The virtual credit card may be tied with the electronic account and/or the exchange resource account stored in the data storage of the first server. The first server may provide the cardholder means to access the card, such as an additional user interface to access the card via a terminal device. The access to the virtual credit card may be provided to the cardholder after the verification of the cardholder is passed. Any verification means, either currently known or later developed, may be used by the first server for such verification purpose. By this way, the user does not need to have a physical credit card.

In case the virtual credit card tied with the electronic exchange account stored in the data storage of the first server, the historical data stored or obtained by the first server may be used to verify the cardholder for the virtual credit card. In addition, the terminal device may be the cardholder's own mobile phone, the terminal device may provide built-in feature for the verification, such as fingerprint verification.

As such, the first server may determine whether the access to the virtual credit card is authorized, by using at least one of following methods: 1, newly developed verification process such as asking the cardholder to input the passcode in a user interface; 2, existing verification from electronic exchange account and/or electronic resource account (history data may be used); or 3, the third party built-in verification, for example, built-in mobile phone access verification.

After the verification is passed, an indicator may be saved in the first server and the cardholder may use the virtual credit card to make payments.

The electronic account saved in the first server of the system may be one of: an electronic social account, an electronic payment account, an electronic game account, an email account, a financial account, and an electronic service account.

The first server of the system may be further configured to: acquire user history data stored in the data storage according to the electronic account, and send the user history data to the second server; and the second server of the system may be further configured to: receive the user history data by the second server, and create the virtual credit card account by using the user history data.

The second server of the system may be further configured to: analyze the user history data by accessing at least one of: user payment data, user social data, historical email data, historical financing data and historical login data that are included in the received user history data from the first server; and determine the credit limit of the virtual credit card account according to the analyzed user history data.

The first server of the system may be further configured to validate the terminal device, wherein the first server may be configured to: receive, from the second server, a validation terminal identity that is bound to the credit account stored in the second server; send validation information to a second user interface according to the received validation terminal identity; in response to send the validation information, receive second validation information from the terminal device; determine whether the second validation information matches the validation information; and validate the terminal device by saving an indicator in the data storage to indicate the terminal device is validated if the second validation information matches the validation information.

The first server of the system may be further configured to: validate the terminal device by using at least one of: SMS validation, instant messaging validation, voice validation, and email validation.

The second server of the system may be further configured to: send the account information of the virtual credit card account to the first server; and the first server of the system may be further configured to: receive the account information of the virtual credit card account, and bind the virtual credit card associating with the virtual credit card account and the electronic account saved in the data storage.

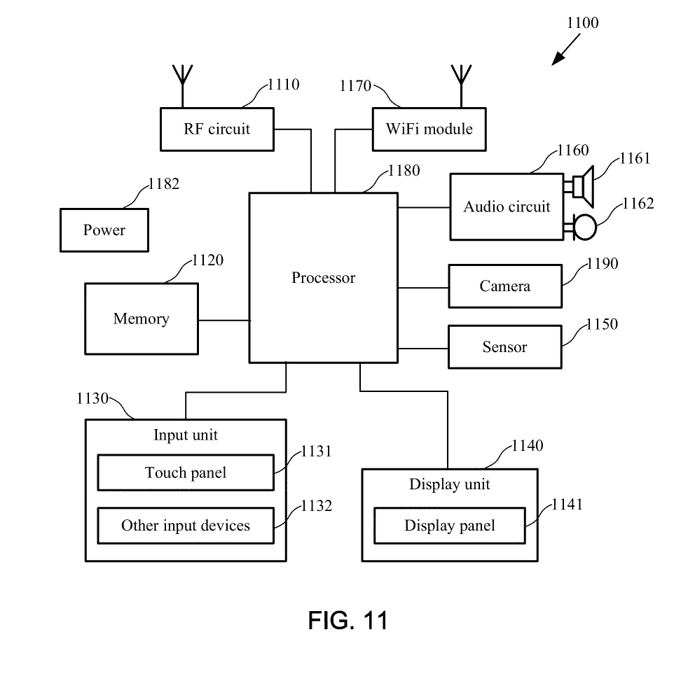

As shown in FIG. 11, it shows a frame diagram of terminal according to the example of present disclosure, the terminal is configured to implement the method for creating credit card account according to the example of present disclosure, the terminal according to the example of present disclosure can include one or more following parts: a processor for executing computer program instructions to complete various processes and methods, a random access memory (RAM), and a read only memory (ROM) for information and storing program instructions, a memory for storing data and information, an I/O devices, an interface, an antenna, and so on. The detail is as follow.

The terminal 1100 can include a RF (Radio Frequency) circuit 1110, a memory 1120, an input unit 1130, a display unit 1140, a sensor 1150, an audio circuit 1160, a wife (wireless fidelity) module 1170, a processor 1180, power 1182, a camera 1190, and other parts. The person skilled in the art can understand that the structure of the terminal shown in FIG. 11 does not limit the terminal and can include more or fewer components than shown in FIG. 11, or a combination of some of the components, or a different arrangement of components.

The following describes various components of the terminal 1100 in detail with reference to the FIG. 11.

RF circuit 1110 may be used to receive and send message, or send and receive signals of during a call, in particular, receive and send the downlink message of the base station to the processor 1180 to process; further, send the uplink data of the design to the base station. Typically, RF circuit may include but not limited to antenna, at least one amplifier, transceiver, couplers, LNA (Low Noise Amplifier, LNA), diplexer, and so on. In addition, The RF circuit 1110 can also communicate with other devices via wireless communication and network. The wireless communication can use any communication Standards or protocols, including but not limited to GSM (Global System of Mobile communication), GPRS (General Packet Radio Service), CDMA (Code Division Multiple Access), WCDMA (wideband Code Division Multiple Access), LTE (Long Term Evolution), e-mail, SMS (Short Messaging Service), and so on.

Memory 1120 may be used to store software programs and modules, the processor 1180 executes various functions application and data processing of terminal 1100 by running software programs and modules in memory 1120. The memory 1120 can mainly include a storage program area and a storage date area, wherein the storage program area can store an operating system, the application required by at least one function (such as sound playback, image playback, etc.); The storage date area can store the data (such as audio data, phone book, etc.) created according to the usage of the terminal 1100. In addition, the memory 1120 can include high-speed random access memory, and can also include non-volatile memory, such as at least one disk storage device, flash memory device, or other easily Volatile solid-state memory devices.

An input unit 1130 may be used to receive inputted number or character information, and generate inputting key signal related to the user settings and function control of the terminal 1100. Specifically, the input unit 1130 can include a touch panel 1131, and other input devices 1132. The touch panel 1131, is also known as touch screen, can collect touch operations of the user on or near it (such as operations of user using finger, stylus and any other suitable object or attachment on or near the touch panel 1131), and drive the corresponding connecting device according to a preset program. Optionally, the touch panel 1131 can include a touch detection device and a touch controller. The touch detection device detects the position a user touches, detects and sends the signal brought by the touch operation to the touch controller; the touch controller receives touch information from the touch detecting device, and converts it into contact coordinates, and then sends the contact coordinates to the processor 1180, and can receive and execute commands sent by the processor 1180. Further, resistive, capacitive, infrared and surface acoustic wave, and many other types touch panel may be used to achieve the touch panel 1131. In addition to the touch panel 1131, the input unit 1130 can also include other input devices 1132. In detail, the other input devices 1132 can include but are not limited to one or more of the physical keyboard, function keys (such as volume control keys, key switches, etc.), the trackball, the mouse, the operating lever, and so on.

The display unit 1140 may be used to display information inputted by the user or information provided to the user and various menus of terminal 1100. The display unit 1140 can include a display panel 1141; optionally, LCD (Liquid Crystal Display), OLED (Organic Light-Emitting Diode), and other form may be used to configure the display panel 1141. Further, the touch panel 1131 can cover the display panel 1141, the touch panel 1131 sends the touch operations to the processor 1180 after detecting there are the touch operations existing on or near it, and then the processor 1180 provides corresponding visual output in the display panel 1141 according to the type of touch event. Although the touch panel 1131 and the display panel 1141 achieve the input and output functions of the terminal 1100 as two separate component shown in FIG. 11; in some examples, the touch panel 1131 and the display panel 1141 may be integrated together to achieve the input and output functions of the terminal 1100.

The terminal 1100 can further include at least one sensor 1150, such as a gyro sensor, magnetic sensors, optical sensors, motion sensors, and other sensors. In detail, the optical sensor can include ambient light sensor and proximity sensor, wherein the ambient light sensor can adjust the brightness of the display panel 1141 according to the brightness of the ambient light, the proximity sensor can close the display panel 1141 and/or backlight, when the terminal 1100 moves nearby the ears. As one type of the motion sensor, an acceleration sensor can detect the magnitude of acceleration of the respective directions (typically axis, in general), the direction and speed of gravity may be detected by the acceleration sensor when stationary, the acceleration sensor may be used to identify terminal posture applications (such as vertical screen switching, related games, magnetometer calibration posture), vibration to recognize related functions (such as pedometers, percussion), etc.; barometers, hygrometers, thermometers, infrared sensors, and other sensors may be configured to the terminal 1100, which will not be repeated here.

An audio circuit 1160, a speaker 1161, a microphone 1162 can provide audio interface between the user and the terminal 1100. The audio circuitry 1160 can send the electrical signal which is transformed from the received audio data by the audio circuitry 1160 to the speaker 1160, the speaker 1161 transforms the electrical signal into a sound signal, and outputs it; on the other hand, the microphone 1162 transforms the collected sound signal into a electrical signal, the audio circuit 1160 transforms the received electrical signal into audio data and outputs it to the processor 1180 to be processed, after processing by the processor 1180, the RF circuit 1110 sends it to the other terminal, or outputs audio data to the memory 1120 for further processing.

Wifi is a short-range wireless transmission technology, the terminal 1100 helps users send and receive email, browse the web, and access streaming media, and the like through Wifi module 1170; it provides users with wireless broadband Internet access. Although FIG. 11 shows a Wifi module 1170, it should be understood that it is not an integral part of the terminal 1100, it may be omitted as required within the scope which is not changing the essence of disclosure.

The processor 1180 is the control center of the terminal 1100, connects various parts of the terminal by using various interfaces and connections, executes various functions and processing data of the terminal 1100 by running or executing software program and/or module stored in the memory 1120 and by calling the data stored in the memory 1120, and thus monitor the terminal overall. Optionally, the processor 1180 can include one or more processing units; Preferably, the processor 1180 can integrated the application processor and the modem processor, wherein the application processor mainly process operating system, user interface, and applications program, and so on, the modem processor mainly process wireless communication. It should be understood that the above processor can also be not integrated into the processor 1180.

The terminal 1100 further may include a power supply 1182 (such as batteries) which supplies power to each part, preferably, the power supply may be connected logically with the processor 1180 through a power management system, and thus achieve functions of managing charging, discharging and power consumption through the power management system.

The camera 1190 is usually composed of camera lens, image sensor, interface, digital signal processor, CPU, display screen and so on. The camera lens is fixed at the top of the image sensor, it can change the focus by manually adjusting the camera lens; the image sensor is equivalent to the “film” of traditional camera, which is the heart of capturing images by the camera; the interface is used to connect the camera lens with the terminal motherboard by using cable, board to board connectors, a spring-type connection, send the collected images to the memory 1120; the digital signal processor processes the collected images through mathematical operations, transforms the collected simulated images into digital images and sends it to the memory 1120 through the interface.

Although not shown, the terminal 1100 can also include bluetooth module, and so on, which are not repeated here.

The terminal 1100 may include a memory and one or more modules in addition to one or more processors 1180, wherein one or more modules are stored in the memory, and are configured to be executed by one or more processors. The one or more above modules are used to execute method for creating credit card account, the method for creating credit card account is shown in FIG. 2 and corresponding example to the FIG. 2; and/or, the method for creating credit card account is shown in FIG. 3A and corresponding example to the FIG. 3.

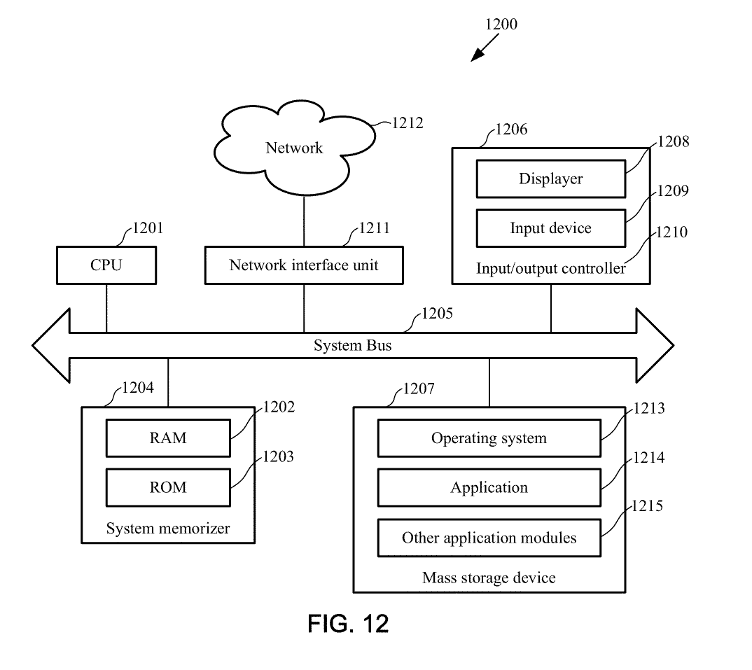

As shown in FIG. 12, it shows a structural schematic of a server according to an example of the present disclosure, the server may be the first server, can also be the second server. The server 1200 may include a central processing unit (CPU) 1201, a random access memory (RAM) 1202, and a system memory 1204 of read only memory (ROM) 1203, and a system bus 1205 connecting a system memory 1204 and the central processing unit 1201. The servers 1200 also include a basic input/output system 1206 (I/O system) for transferring information between the respective devices in the computer, an operating system 1213 for storing, application programs 1214 and a large capacity storage device 1207 of other modules 1215.

The said basic input/output system 1206 may include a displayer 1208 for displaying information, and an input device 1209 such as a mouse, a keyboard and other input devices for the user to input information. The display device 1208 and the input device 1209 are connected to the central processing unit 1201 by being connected to the input and output controller 1210 of the system bus 1205. The basic input/output system 1206 can also include the input and output controller 1210 to receive and process the input from the keyboard, the mouse, or the electronic stylus and other devices. Similarly, the input and output controller 1210 further provides outputting to the display, the printer, or other output devices.

The large capacity storage device 1207 is connected to the central processing unit 1201 by being connected to a mass storage controller (not shown) of the system bus 1205. The large capacity storage device 1207 and its associated computer readable medium provide nonvolatile storage for the server 1200. That is, the large capacity storage device 1207 can include computer readable medium, either transitory or non-transitory, such as a hard disk or CD-ROM drive (not shown).

In general, the computer readable medium can include computer storage medium and communication medium. Computer storage medium may include any methods for storing information such as computer readable instructions, data structure, program modules or other data and other information or technical implementation volatile and nonvolatile, removable and non-removable medium. Computer storage medium may include RAM, ROM, EPROM, EEPROM, flash memory or other solid state memory technology, CD-ROM, DVD, or other optical storage, magnetic cassettes, magnetic tape, magnetic disk storage or other magnetic storage devices. Of course, those persons skilled in the art can understand that the computer storage medium is not limited to the above types. The above-mentioned system memory 1204 and the large capacity storage device 1207 may be collectively called memory.

The server 1200 can also be connected to a remote computer on the network to run through network, such as the internet according to various examples of the present disclosure, That is, the server 1200 may be connected to the network 1212 by being connected to the network interface unit 1211 of the system bus 1205, or may be connected to other types of networks and remote computer system by using the network interface unit 1211 (not shown).

The memory further may include one or more than one programs, the one or more than one programs are stored in the memory, the one or more than one programs are used to execute the method for creating credit card account, the method for creating credit card account is shown in FIG. 2 and corresponding example to the FIG. 2; and/or, the method for creating credit card account is shown in FIG. 3A and corresponding example to the FIG. 3.

It should be noted that when the device for creating credit card account according to the above-mentioned examples is creating credit card account, it only takes delineation of the above-mentioned functional modules for example to illustrate, in reality, the above-mentioned functions may be assigned to be completed by different functional modules as required, that is to divide the internal structure of the device for creating credit card account into different functional modules to complete all or part of the functions described above. In addition, the device for creating credit card account according to the above-mentioned examples and the method example for creating credit card account belong to the same idea, and its specific implementation process is detailed in the method example and will not be repeated here.

The serial numbers of the examples of the present disclosure above-mentioned do not to represent the merits of the example, but only helps to describe.

Those person skilled in the art can clearly understand that some or all steps of the above-described examples may be achieved by hardware as well as instructing relevant hardware through procedure, the said procedure may be stored in computer readable storage medium, the above-mentioned storage medium may be a ROM, a disk, or a CD, etc.

The foregoing descriptions are merely exemplary examples of the present disclosure, but are not intended to limit the present disclosure. Any modifications, equivalent substitutions, and improvements made within the spirit and principle of the present disclosure shall fall within the protection scope of the present disclosure.

What is claimed is:

1. A device for creating a virtual credit card comprising:
a first server having a data storage containing pre-stored real-name information and associated electronic account information, wherein the first server is configured to:
acquire a subset of real-name information from a user interface of a terminal device wherein the subset of the real-name information comprises at least a portion of a user name or identification number associated with the electronic account saved in the data storage;
search for the real-name information stored in the data storage using the subset of the real-name information;
send the real-name user information to a second server if the real-name information is found in the data storage;
receive a notification from the second server if a credit card account stored in the second server associates with the real-name information, and a virtual credit card is created by the second server; and
store the virtual credit card associated with the virtual credit card account.

2. The device of claim 1, wherein the electronic account saved in the first server is one of: an electronic social account, an electronic payment account, an electronic game account, an email account, a financial account, and an electronic service account.

3. The device of claim 1, wherein the first server is configured to: acquire user history data stored in the data storage according to the electronic account, and send the user history data to the second server wherein the user history data is used by the second server for creating the virtual credit card account.

4. The device of claim 1, wherein the first server is configured to validate the terminal device, wherein the first server is configured to:
receive, from the second server, a validation terminal identity that is bound to the credit card account stored in the second server;
send validation information to a second user interface according to the received validation terminal identity;
in response to send the validation information, receive second validation information from the terminal device;
determine whether the second validation information matches the validation information; and
validate the terminal device by saving an indicator in the data storage to indicate the terminal device is validated if the second validation information matches the validation information.

5. The device of claim 4, wherein the first server is configured to:
validate the terminal device by using at least one of: SMS validation, instant messaging validation, voice validation, and email validation.

6. The device of claim 1, wherein the first server is configured to:
receive the account information of the virtual credit card account from the second server, and bind the virtual credit card associating with the virtual credit card account and the electronic account saved in the data storage.

7. A system for creating virtual credit to be stored in a data storage, comprising: a first server, a terminal device having a user interface communicating to the first server, and a second server communicating to the first server;
wherein the terminal device is configured to:
acquire a subset of real-name information from a user interface, wherein the subset of the real-name information comprises at least a portion of: a user name or a user identification number wherein the portion is associated with an electronic account saved in the first server;
wherein the first server is configured to:
receive the subset of the real-name information, search the real-name information stored in the data storage with the subset of the real-name information, wherein the real-name information is pre-stored in the data storage;
upon the real-name information is found in the data storage, send the real-name user information to a second server;
wherein the second server is configured to:
receive the real-name user information, and find whether the real-name information associates with a credit card account stored in the second server;
after finding the credit card account is stored in the second server, create a virtual credit card account; and
wherein the first server is configured to:
store the virtual credit card associated with the virtual credit card account in the data storage.

8. The system of claim 7, wherein the electronic account saved in the first server is one of: an electronic social account, an electronic payment account, an electronic game account, an email account, a financial account, and an electronic service account.

9. The system of claim 7, wherein:
the first server is configured to:
acquire user history data stored in the data storage according to the electronic account, and send the user history data to the second server; and
the second server is configured to:
receive the user history data by the second server, and create the virtual credit card account by using the user history data.

10. The system of claim 9, wherein the second server is configured to:
analyze the user history data by accessing at least one of: user payment data, user social data, historical email data, historical financing data and historical login data that are included in the received user history data from the first server; and
determine the credit limit of the virtual credit card account according to the analyzed user history data.

11. The system of claim 7, wherein the first server is configured to validate the terminal device, wherein the first server is configured to:
receive, from the second server, a validation terminal identity that is bound to the credit card account stored in the second server;
send validation information to a second user interface according to the received validation terminal identity;
in response to send the validation information, receive second validation information from the terminal device;
determine whether the second validation information matches the validation information; and
validate the terminal device by saving an indicator in the data storage to indicate the terminal device is validated if the second validation information matches the validation information.

12. The system of claim 11, wherein the first server is configured to:
validate the terminal device by using at least one of: SMS validation, instant messaging validation, voice validation, and email validation

13. The system of claim 7, wherein:
the second server is configured to:
send the account information of the virtual credit card account to the first server;
the first server is configured to:
receive the account information of the virtual credit card account, and bind the virtual credit card associating with the virtual credit card account and the electronic account saved in the data storage.

14. A method for creating a virtual credit card to be stored in a data storage, comprising:
acquiring a subset of real-name information from a user interface of a terminal device, wherein the subset of the real-name information comprises at least a portion of: a user name or a user identification number wherein the portion is associated with an electronic account saved in a first server;
receiving, by the first server, the subset of the real-name information, searching the real-name information stored in the first server with the subset of the real-name information, wherein the real-name information is pre-stored in the data storage of the first server;
upon the real-name information is found in the first server, sending the real-name user information to a second server by the first server;
receiving, by the second server, the real-name user information by the second server, and finding whether the real-name information associates with a credit card account stored in the second server;
after finding the credit card account is stored in the second server, creating, by the second server, a virtual credit card account; and
storing the virtual credit card associated with the virtual credit card account in the data storage of the first server.

15. The method of claim 14, wherein the electronic account is one of: an electronic social account, an electronic payment account, an electronic game account, an email account, a financial account, and an electronic service account.

16. The method of claim 14, before creating the virtual credit card account, further comprising:
acquiring user history data stored in the data storage of the first server according to the electronic account, and sending the user history data to the second server; and
receiving the user history data by the second server, and creating the virtual credit card account by using the user history data.

17. The method of claim 16, wherein creating the virtual credit card account by using the user history data comprises:
analyzing the user history data by accessing at least one of: user payment data, user social data, historical email data, historical financing data and historical login data that are included in the user history data received by the second server; and
determining, by the second server, the credit limit of the virtual credit card account according to the analyzed user history data.

18. The method of claim 14, before creating the virtual credit card account, further comprising: validating the terminal device by the first server, wherein validating the terminal device comprises:
receiving, by the first server from the second server, a validation terminal identity that is bound to the credit card account stored in the second server;
sending validation information to a second user interface according to the validation terminal identity received by the first server;
in response to sending the validation information, receiving second validation information to be validated from the terminal device;
determining whether the second validation information matches the validation information; and
validating the terminal device by saving an indicator in the data storage of the first server to indicate the terminal device is validated if the second validation information matches the validation information.

19. The method of claim 18, wherein validating user terminal information by the first server further comprising:
validating the terminal device by using at least one of: SMS validation, instant messaging validation, voice validation, and email validation.

20. The method of claim 14, after creating the virtual credit card account, further comprising:
sending the account information of the virtual credit card account to the first server by the second server;
receiving the account information of the virtual credit card account by the first server, and binding, by the first server, the virtual credit card associating with the virtual credit card account and the electronic account saved in the data storage of the first server.
